(19) United States
(12) Patent Application Publication
(10) Pub. No.: US 2025/0206564 A1
(43) Pub. Date: Jun. 26, 2025

(54) SPOOL FOR RECEIVING AN OPTICAL FIBER AND METHOD OF MAKING THE SAME

(71) Applicant: CORNING INCORPORATED, CORNING, NY (US)

(72) Inventors: Andrew James Emborsky, Wilmington, NC (US); Julio Cesar Mendoza, Harrisburg, NC (US); Mark Antonio Oliver, JR., Charlotte, NC (US)

(21) Appl. No.: 18/969,401

(22) Filed: Dec. 5, 2024

Related U.S. Application Data
(60) Provisional application No. 63/613,896, filed on Dec. 22, 2023.

(51) Int. Cl. B65H 75/18; B29C 45/14; B29K 105/04; B29L 31/00; B65H 75/14; B65H 75/50

(52) U.S. Cl. CPC B65H 75/185; B65H 75/14; B65H 75/50; B29C 45/14622; B29K 2105/04; B29L 2031/704; B65H 2701/32

(57) ABSTRACT

A spool for receiving an optical fiber including: (a) an outer cylinder portion including (i) an outer surface, (ii) an inner surface, and (iii) a thickness therebetween; and (b) a first outboard flange and a second outboard flange each extending radially outward from the outer surface of the outer cylinder portion, the first outboard flange, the second outboard flange, and the outer surface of the outer cylinder portion defining a primary barrel portion of the spool. The thickness of the outer cylinder portion is substantially constant between the first outboard flange and the second outboard flange. A method of manufacturing the same including (i) injecting molding an injection molded monolith including the first outboard flange, the second outboard flange, and the cylindrical portion therebetween, and (ii) over-molding a polymeric cushioning material over the cylindrical portion of the injection molded monolith between the first outboard flange and the second outboard flange.

This Application claims the benefit of priority to U.S. Provisional Patent Application Ser. No. 63/613,896 filed on Dec. 22, 2023, the content of which is relied upon and incorporated herein by reference in its entirety.

### FIELD OF THE DISCLOSURE

The present disclosure pertains to a spool for the winding of optical fiber thereupon and a method of manufacturing the same.

### BACKGROUND

After being drawn from an optical fiber preform at a draw tower, the optical fiber is typically wound around a bulk spool. The bulk spool can hold many kilometers of optical fiber (e.g., 400 km or more). From the bulk spool, the optical fiber can be wound in shorter lengths onto smaller spools, which are sometimes referred to as shipping spools (hereinafter, just “spool”). The vast majority of the length of the optical fiber is wrapped around a primary barrel of the spool. The spool, with the optical fiber wound thereon, can be shipped to a customer or held for internal processing and testing by the manufacturer, among other options.

Sometimes the spool has a plastic composition and is molded in two parts, each part roughly accounting for a different half of the spool cross-sectioned orthogonal to an axis of rotation of the spool. The two parts are then welded together (e.g., ultrasonically) at the primary barrel and then a piece of cushioning material (e.g., foam) is wrapped over the primary barrel and secured thereto via adhesive or mechanical interlock.

However, there are problems with the two-part spool. The welding of the two parts and the application of the cushioning material requires a suboptimal amount of time and incurs a suboptimal level of expense. Manufacturers of optical fiber can utilize large quantities of spools per year. Thus, the suboptimal time and expense in finalizing manufacture of the spools is thus magnified. Further, because of the welding of the two parts, the spool can be completed out of dimensional specification, which requires a high-level of inspection and suboptimal levels of scrap spools. Still further, because of the welding of the two parts, a suboptimal high percentage of the plastic material has to be virgin, rather than recycled. Moreover, the cushioning material is susceptible to lifting from the primary barrel during the high-speed revolution of the spool during winding of the optical fiber.

### SUMMARY OF THE DISCLOSURE

The present disclosure addresses that problem by forming the primary barrel portion of the spool with a single plastic piece (referred to herein as an injection molded monolith) with an outer cylinder between two outboard flanges and then over-molding the outer cylinder with a polymeric cushioning material. Forming the plastic part of the spool in a single piece (the injection molded monolith) avoids the need to weld two separately molded plastic parts together. Further, the injection molded monolith is formed within dimensional specifications and avoids the need for inspection and suboptimal levels of scrap. Still further, the injection molded monolith can be made with recycled plastic material because the loss of strength at a weld line is avoided. Finally, the polymeric cushioning material is over-molded over the injection molded monolith as contiguous polymeric cushioning material. Thus, there is no edge that could lift during high-speed revolution of the spool.

According to a first aspect of the present disclosure, a spool for receiving an optical fiber comprises: (a) an outer cylinder portion through which an axis of rotation of the spool extends, the outer cylinder portion comprising (i) an outer surface facing away from the axis of rotation, (ii) an inner surface facing the axis of rotation, the outer cylinder portion extending parallel to the axis of rotation from a first end to a second end, and (iii) a thickness between the outer surface and the inner surface; (b) an inner cylinder portion through which the axis of rotation of the spool extends, the inner cylinder portion comprising (i) an outer surface facing the inner surface of the outer cylinder portion, (ii) an inner surface facing the axis of rotation and defining an inner channel, the inner cylinder portion extending parallel to the axis of rotation from a first end and a second end; (c) struts extending between the inner surface of the outer cylinder portion and the outer surface of the inner cylinder portion, the struts extending axially along the axis of rotation between (i) a first end terminating near the first end of the inner cylinder portion and the first end of the outer cylinder portion and (ii) a second end terminating near the second end of the inner cylinder portion and the second end of the outer cylinder portion, and the struts positioned radially about the axis of rotation, wherein the outer cylinder portion, the inner cylinder portion and the struts define outer channels; and (d) a first outboard flange and a second outboard flange each extending radially outward from the outer surface of the outer cylinder portion proximate the first end and the second end respectively of the outer cylinder portion, the first outboard flange, the second outboard flange, and the outer surface of the outer cylinder portion defining a primary barrel portion of the spool; wherein, the thickness of the outer cylinder portion is substantially constant, along a plane extending through the thickness and the axis of rotation and between the first outboard flange and the second outboard flange.

According to a second aspect of the present disclosure, the spool of the first aspect is presented, wherein the outer cylinder portion is jointless and without a weld line between the first outboard flange and the second outboard flange.

According to a third aspect of the present disclosure, the spool of any one of the first through second aspects is presented, wherein the outer cylinder portion further comprises at least one projection that projects out of the inner surface of the outer cylinder portion toward the axis of rotation, the at least one projection extending axially parallel to the axis of rotation between the first end and the second end of the outer cylinder portion.

According to a fourth aspect of the present disclosure, the spool of any one of the first through third aspects is presented, wherein the outer cylinder portion further comprises indentions into the outer surface toward the axis of rotation, each of the indentions extending axially parallel to the axis of rotation between the first outboard flange and the second outboard flange.

According to a fifth aspect of the present disclosure, the spool of any one of the first through fourth aspects is presented, wherein the inner cylinder portion further comprises projections that project out of the inner surface and into the inner channel toward the axis of rotation, each of the projections extending axially parallel to the axis of rotation between the first end and the second end of the inner cylinder portion.

According to a sixth aspect of the present disclosure, the spool of the fifth aspect is presented, wherein some of the projections are radially aligned with the some of the struts and some of the projections are not aligned with any of the struts.

According to a seventh aspect of the present disclosure, the spool of any one of the first through sixth aspects is presented, wherein (i) the inner cylinder portion further comprises a thickness between the outer surface and the inner surface, and (ii) the thickness of the inner cylinder portion is substantially constant, along a plane extending through the thickness and the axis of rotation and between the first outboard flange and the second outboard flange.

According to an eighth aspect of the present disclosure, the spool of any one of the first through seventh aspects is presented, wherein at least some of the struts further comprise an aperture disposed near the second end of the struts.

According to a ninth aspect of the present disclosure, the spool of any one of the first through eighth aspects is presented, wherein at least some of the struts comprise an inner finger portion and an outer finger portion separated from the inner finger portion by a gap open at the second end of the struts, the gap decreasing toward the first end of the struts.

According to a tenth aspect of the present disclosure, the spool of any one of the first through ninth aspects is presented, wherein a first radial wall disposed between the outer cylinder portion and the inner cylinder portion near the first ends thereof and at least partially closing the outer channels but not closing the inner channel.

According to an eleventh aspect of the present disclosure, the spool of any one of the first through tenth aspects is presented, wherein the second outboard flange comprises (i) an outer edge that extends radially around the axis of rotation, (ii) an inner side orthogonal to the axis of rotation and that faces the first outboard flange, (iii) an outer side that faces away from the first outboard flange, and (iv) a slot open at the outer edge, the inner side, and the outer side of the second outboard flange, the slot disposed at an acute angle relative to the inner side and extending to the outer surface of the outer cylindrical portion.

According to a twelfth aspect of the present disclosure, the spool of the eleventh aspect is presented, wherein (a) the slot comprises (i) an inboard side disposed at the inner side of the second outboard flange and (ii) an outboard side disposed at the outer side of the second outboard flange, (b) the second outboard flange further comprises a lead-in surface and a working surface, the lead-in surface and the working surface opposing each other, (c) the lead-in surface of the second outboard flange is serrated and tapers to the outer edge of the second outboard flange, and (d) a slot gap separates lead-in surface and the working surface, and the slot gap increases from the inboard side toward the outboard side.

According to a thirteenth aspect of the present disclosure, the spool of the twelfth aspect is presented, wherein a radial distance from the axis of rotation of the working surface decreases from the inboard side of the slot to the outboard side of the slot.

According to a fourteenth aspect of the present disclosure, the spool of the first through thirteenth aspect is presented, wherein (i) second outboard flange is inset axially toward the first outboard flange from the second end of the outer cylinder portion, and (ii) a portion of the outer surface of the outer cylinder portion is exposed axially outward of the second outboard flange.

According to a fifteenth aspect of the present disclosure, the spool of the first through fourteenth aspects is presented, wherein the outer cylinder portion, the inner cylinder portion, the struts, the first outboard flange, and the second outboard flange are all integrally formed from a plastic composition in common as an injection molded monolith.

According to a sixteenth aspect of the present disclosure, the spool of the fifteenth aspect is presented, wherein the plastic composition is 100 percent recycled plastic material.

According to a seventeenth aspect of the present disclosure, the spool of any one of the first through sixteenth aspects is presented, wherein a polymeric cushioning material disposed on the outer surface of the outer cylinder portion between the first outboard flange and the second outboard flange.

According to an eighteenth aspect of the present disclosure, the spool of the seventeenth aspect is presented, wherein the polymeric cushioning material comprises (i) an outer surface facing away from the axis of rotation, (ii) an inner surface contacting the outer surface of the outer cylinder portion, and (iii) a thickness between the outer surface and the inner surface.

According to a nineteenth aspect of the present disclosure, the spool of the eighteenth aspect is presented, wherein (i) the outer cylinder portion further comprises indentions into the outer surface toward the axis of rotation, each of the indentions extending axially parallel to the axis of rotation between the first outboard flange and the second outboard flange, and (ii) the polymeric cushioning material further comprises projections out of the inner surface of the polymeric cushioning material toward the axis of rotation, the projections residing within the indentions of the outer cylinder portion.

According to a twentieth aspect of the present disclosure, the spool of any one of the eighteenth through nineteenth aspects is presented, wherein the polymeric cushioning material is seamless and jointless.

According to a twenty-first aspect of the present disclosure, the spool of any one of the eighteenth through twentieth aspects is presented, wherein (i) the outer cylinder portion, the inner cylinder portion, the struts, the first outboard flange, and the second outboard flange are all integrally formed from a plastic composition in common as an injection molded monolith, and (ii) the polymeric cushioning material is over-molded over the outer cylinder portion of the injection molded monolith of the spool between the first outboard flange and the second outboard flange.

According to a twenty-second aspect of the present disclosure, the spool of any one of the first through twenty-first aspects further comprises: a lead meter endcap at least partially covering the outer channels at the second end of the struts, the lead meter endcap comprising: (i) an inner wall disposed radially around the axis of rotation and extending orthogonal to the axis of rotation, (ii) an aperture through the inner wall, the aperture providing access into the inner channel that the inner cylinder portion defines, (iii) an outer wall disposed radially around the inner wall and the axis of rotation and extending orthogonal to the axis of rotation, and (iv) a cylindrical wall disposed radially around the axis of rotation and extending axially inward from the outer wall toward the second outboard flange, the cylindrical wall comprising an outer surface and an inner surface disposed closer to the axis of rotation than the outer surface, and the outer wall includes an outer portion that extends radially outward of the outer surface of the cylindrical wall.

According to a twenty-third aspect of the present disclosure, the spool of the twenty-second aspect is presented, wherein (a) the second outboard flange comprises (i) an outer edge that extends radially around the axis of rotation, (ii) an inner side orthogonal to the axis of rotation and that faces the first outboard flange, and (iii) an outer side that faces away from the first outboard flange, and (b) the outer side of the second outboard flange, the outer surface of the cylindrical wall of the lead meter endcap, and the outer portion of the outer wall of the lead meter endcap define a lead meter barrel.

According to a twenty-fourth aspect of the present disclosure, the spool of the twenty-third aspect is presented, wherein the lead meter endcap is snap-fit attached to the outer cylinder portion and the struts axially outboard of the second outboard flange.

According to a twenty-fifth aspect of the present disclosure, the spool of any one of the twenty-third through twenty-fourth aspects is presented, wherein (i) the lead meter endcap further comprises snap-fit cantilevers, and (ii) the outer cylinder portion and the struts both include snap-fit apertures that cooperate with the snap-fit cantilever of the lead meter endcap to attach the lead meter endcap to the outer cylinder portion and the struts.

According to a twenty-sixth aspect of the present disclosure, a method of manufacturing a spool for optical fiber comprises: (a) a monolith injection molding step comprising injecting molding, from a plastic composition, an injection molded monolith comprising a first outboard flange, a second outboard flange, and a cylindrical portion therebetween; and (b) an over-molding step comprising over-molding, from a plastic composition, a polymeric cushioning material over the cylindrical portion of the injection molded monolith between the first outboard flange and the second outboard flange, wherein the first outboard flange, the second outboard flange, and the polymeric cushioning material define a primary barrel of the spool.

According to a twenty-seventh aspect of the present disclosure, the method of the twenty-sixth aspect is presented, wherein the plastic composition of the monolith injection molding step consists essentially of acrylonitrile butadiene styrene.

According to a twenty-eighth aspect of the present disclosure, the method of any one the twenty-sixth through the twenty-seventh aspects is presented, wherein the plastic composition of the monolith injection molding step consists essentially of recycled plastic.

According to a twenty-ninth aspect of the present disclosure, the method of any one the twenty-sixth through the twenty-eighth aspects is presented, wherein injection molded monolith is formed without a plastic welding step.

According to a thirtieth aspect of the present disclosure, the method of any one the twenty-sixth through the twenty-ninth aspects is presented, wherein the plastic composition of the over-molding step is a foam.

According to a thirty-first aspect of the present disclosure, the method of any one the twenty-sixth through the thirtieth aspects is presented, wherein the plastic composition of the over-molding step is miscible with the plastic composition of the monolith injection molding step.

According to a thirty-second aspect of the present disclosure, the method of any one the twenty-sixth through the thirty-first aspects further comprises: an endcap injection molding step comprising injection molding, from a plastic composition, a lead meter endcap configured to attach to the injection molded monolith and define, along with the second outboard flange of the injection molded monolith, a lead meter barrel of the spool.

According to a thirty-third aspect of the present disclosure, the method of thirty-second aspects further comprises: an endcap attaching step comprising attaching the lead meter endcap, in a snap-fit fashion, to the injection molded monolith.

Additional features and advantages will be set forth in the detailed description which follows and will be readily apparent to those skilled in the art from that description or recognized by practicing the embodiments as described herein, including the detailed description which follows, the claims, as well as the appended drawings.

It is to be understood that both the foregoing general description and the following detailed description are merely exemplary and are intended to provide an overview or framework to understanding the nature and character of the disclosure and the appended claims.

The accompanying drawings are included to provide a further understanding of principles of the disclosure, and are incorporated in, and constitute a part of, this specification. The drawings illustrate one or more embodiment(s) and, together with the description, serve to explain, by way of example, principles and operation of the disclosure. It is to be understood that various features of the disclosure disclosed in this specification and in the drawings can be used in any and all combinations. By way of non-limiting examples, the various features of the disclosure may be combined with one another according to the following embodiments.

### BRIEF DESCRIPTION OF THE FIGURES

The following is a description of the figures in the accompanying drawings. The figures are not necessarily to scale, and certain features and certain views of the figures may be shown exaggerated in scale or in schematic in the interest of clarity and conciseness.

In the drawings:

FIG. 1 is a perspective view of a spool of the present disclosure, illustrating an injection molded monolith, a polymeric cushioning material disposed on the injection molded monolith, and a lead meter endcap attached to the injection molded monolith;

FIG. 2 is an exploded view of the spool of FIG. 1;

FIG. 3 is a perspective view of the injection molded monolith, illustrating an outer cylinder portion, an inner cylinder portion, and struts contiguous with and disposed between the outer cylinder portion and the inner cylinder portion;

FIG. 4 is an elevational view of the injection molded monolith, illustrating a first outboard flange and a second outboard flange defining, at least in part, a primary barrel portion together with an outer surface of the outer cylinder portion;

FIG. 5 is an elevational view of a cross-section of the injection molded monolith taken through line V-V of FIG. 4, illustrating the struts extending radially relative to an axis of rotation of the spool from an outer surface of the inner cylinder portion to an inner surface of the outer cylinder portion;

FIG. 6 is an elevational view of the injection molded monolith illustrating the second outboard flange, the outer cylinder portion, and the inner cylinder portion disposed around the axis of rotation;

FIG. 7 is an elevation view of a cross-section of the injection molded monolith taken through line VII-VII of FIG. 6, illustrating one of the struts including an outer finger portion, an inner finger portion, and a gap therebetween;

FIG. 8 is a magnified view of area VIII of FIG. 5, illustrating the outer cylinder portion of the injection molded monolith including indentations toward the axis of rotation, and the inner cylinder portion of the injection molded monolith including projections extending toward the axis of rotation;

FIG. 9 is an elevation view of the injection molded monolith, illustrating the first outboard flange and a first radial wall disposed around the axis of rotation;

FIG. 10 is a magnified view of area X of FIG. 4, illustrating the injection molded monolith further including a slot through the second outboard flange;

FIG. 11 is a magnified view of area XI of FIG. 6, illustrating the slot through the second outboard flange including lead-in surface facing axially outward away from the first outboard flange;

FIG. 12 is an elevation view of the polymeric cushioning material disposed over the injection molded monolith;

FIG. 13 is an elevation view of a cross-section taken through line XII-XII of FIG. 12, illustrating the polymeric cushioning material disposed radially around the axis of rotation;

FIG. 14 is a magnified perspective view of area XIV of FIG. 13, illustrating the polymeric cushioning material including projections that extend toward the axis of rotation into the indentations into the outer surface of the outer cylinder portion;

FIG. 15 is an elevation view of the lead meter endcap of the spool of FIG. 1, illustrating an outer wall radially around an inner wall, and a transition wall transitioning between the outer wall and the inner wall;

FIG. 16 is an elevation view of a cross-section of the lead meter endcap taken through line XVI-XVI of FIG. 15, illustrating snap-fit cantilevers;

FIG. 17 is an elevation view of the spool of FIG. 1, illustrating the cushioning material further defining the primary barrel portion, and the lead meter endcap and the second outboard flange defining a lead meter barrel;

FIG. 18 is a perspective view of a cross-section of the spool taken through line XVIII-XVIII of FIG. 17, illustrating the injection molded monolith further including projections projecting toward the axis of rotation from the inner surface of inner cylinder portion, and the lead meter endcap attached to the injection molded monolith;

FIG. 19 is a magnified view of area XIX of FIG. 18, illustrating the snap-fit cantilevers of the lead meter endcap engaged with snap-fit apertures of the struts and outer cylinder portion of the injection molded monolith to snap-fit attach the lead meter endcap to the injection molded monolith;

FIG. 20 is a schematic diagram of a method of manufacturing the spool of FIG. 1, illustrating a monolith injection molding step to make the injection molded monolith as a single plastic component, and an over-molding step where the polymeric cushioning material is over-molded onto the injection molded monolith; and

FIG. 21 is the spool of FIG. 1 in use receiving optical fiber from a flying head, first at the lead meter barrel, then through the slot of the second outboard flange, and then onto the primary barrel portion of the spool.

### DETAILED DESCRIPTION

Additional features and advantages will be set forth in the detailed description which follows and will be apparent to those skilled in the art from the description, or recognized by practicing the embodiments as described in the following description, together with the claims and appended drawings.

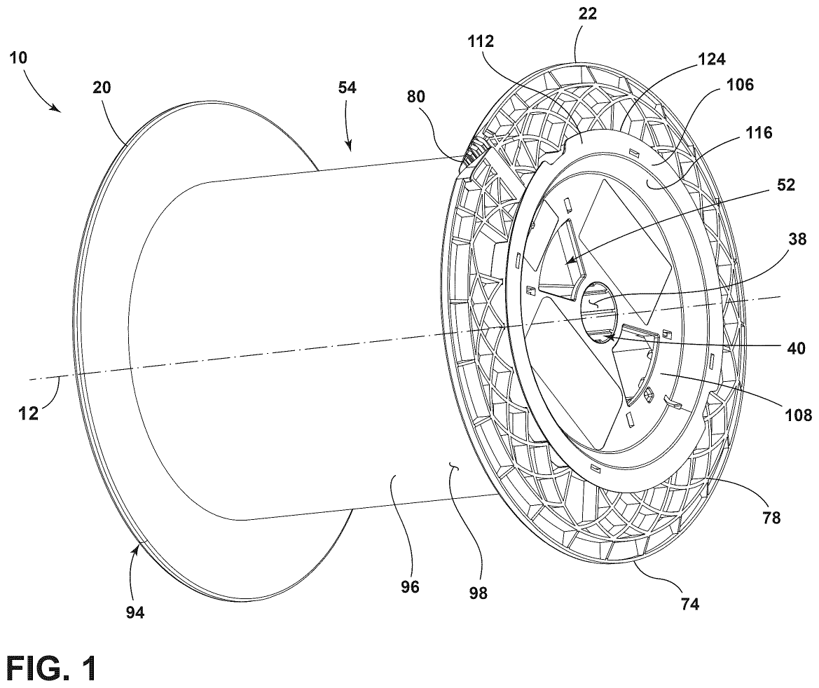

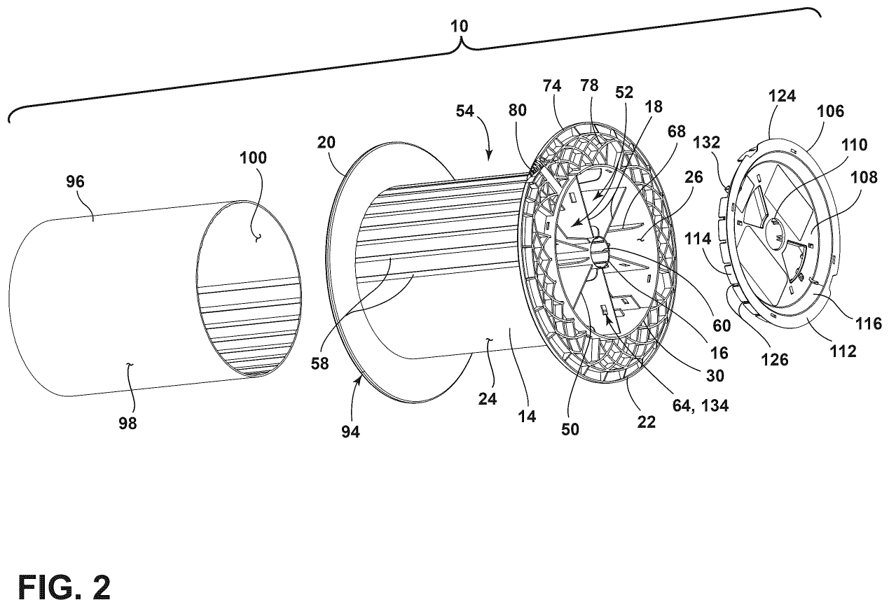

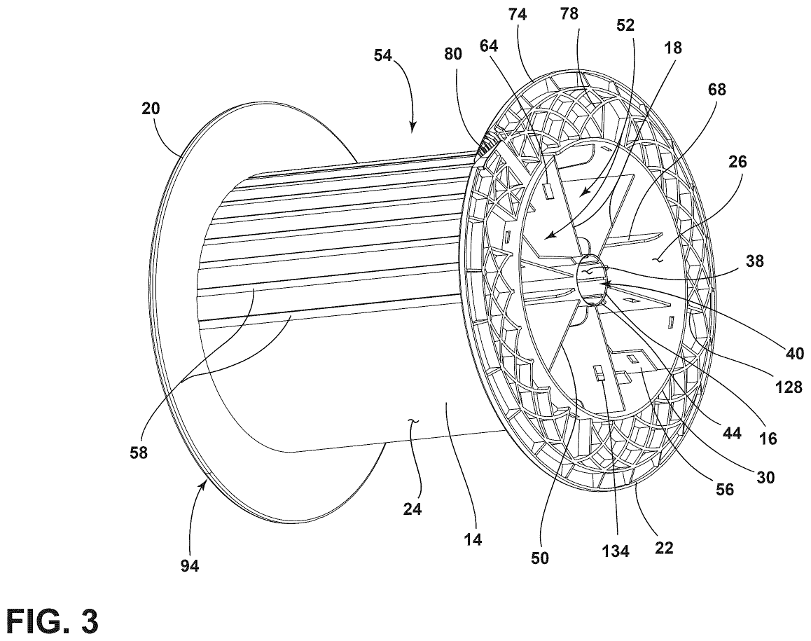

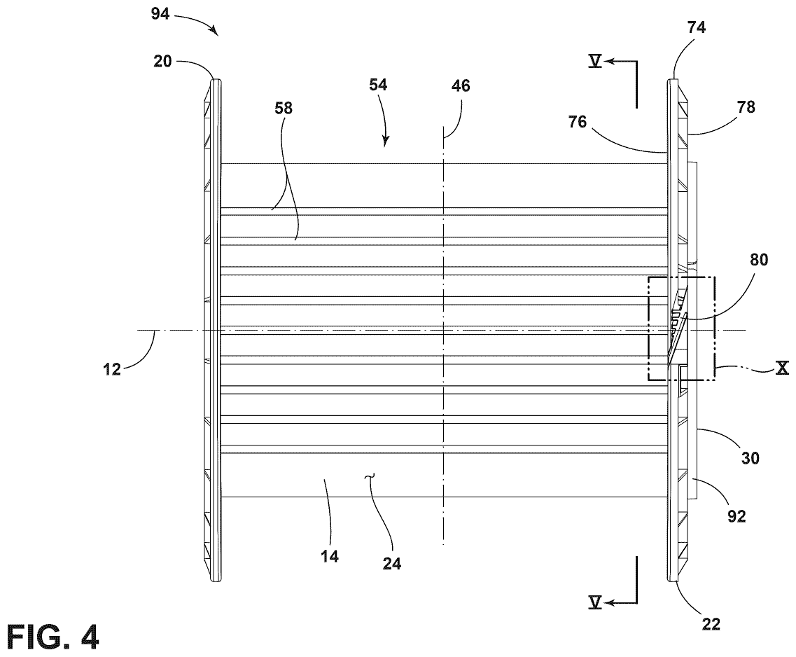

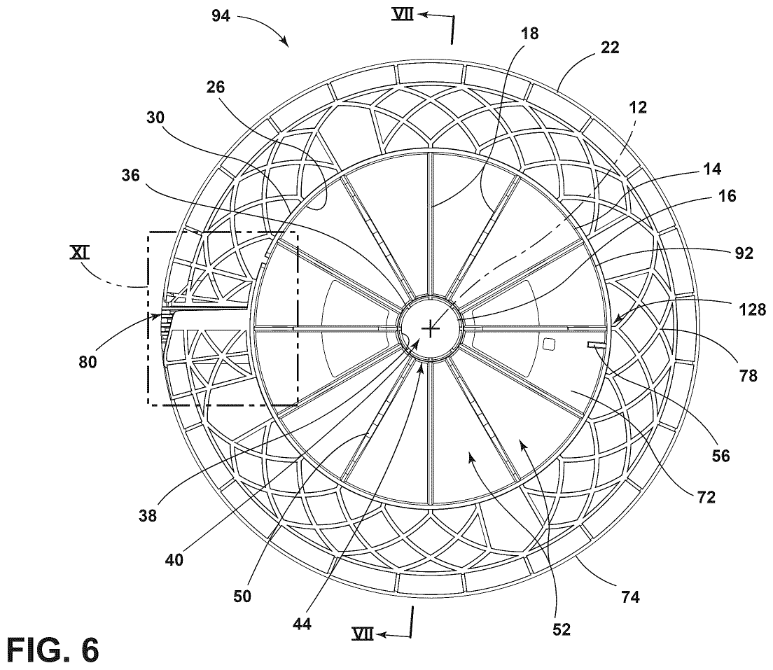

Referring to FIGS. 1-7, a spool 10 for receiving an optical fiber (reintroduced below) includes an axis of rotation 12, an outer cylinder portion 14, an inner cylinder portion 16, struts 18, a first outboard flange 20, and a second outboard flange 22. The spool 10 rotates around the axis of rotation 12 during intended use of the spool 10, as further described below.

The axis of rotation 12 extends through the outer cylinder portion 14. The outer cylinder portion 14 is disposed radially around the axis of rotation 12. The outer cylinder portion 14 includes an outer surface 24 that faces away from the axis of rotation 12. In addition, the outer cylinder portion 14 includes an inner surface 26 facing the axis of rotation 12. The outer cylinder portion 14 further extends axially (relative to the axis of rotation 12) parallel to the axis of rotation 12 from a first end 28 to a second end 30. The outer cylinder portion 14 further includes a thickness 32. The thickness 32 is the radial straight-line distance between the outer surface 24 and the inner surface 26.

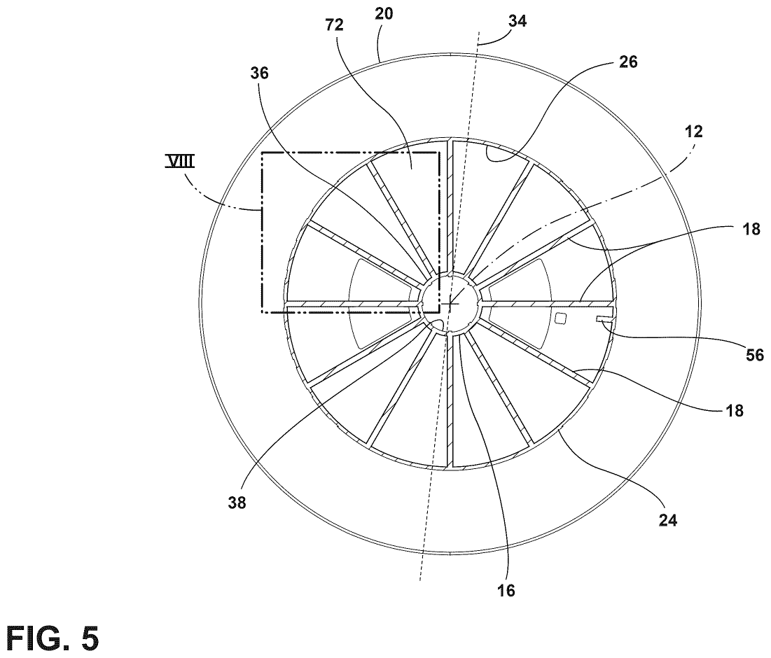

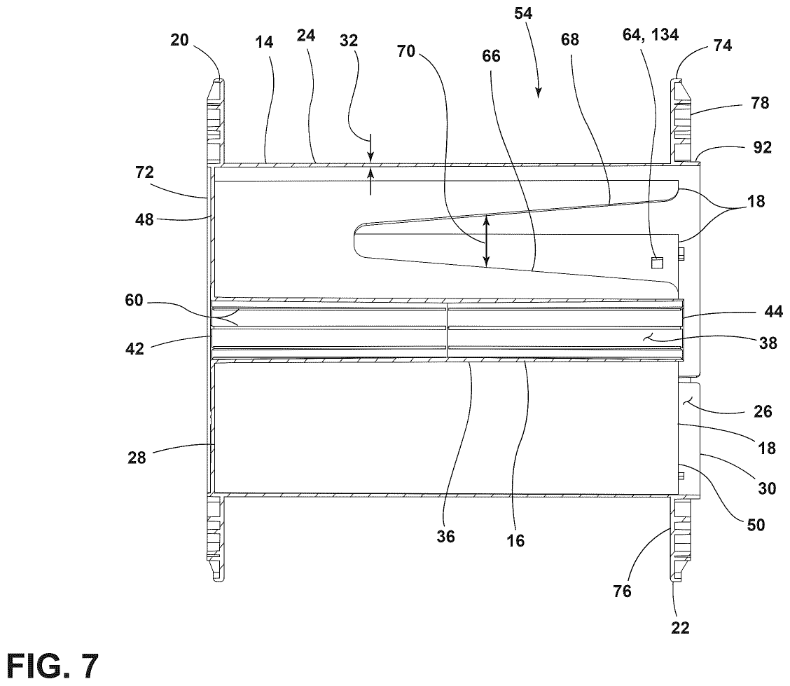

Along a plane 34 extending through the thickness 32 and the axis of rotation 12 (see, e.g., FIGS. 5 and 7), and between the first outboard flange 20 and the second outboard flange 22, the thickness 32 of the outer cylinder portion 14 is substantially constant. As further discussed below, the substantially constant thickness 32 can be achieved by injection molding the outer cylinder portion 14, the inner cylinder portion 16, the struts 18, the first outboard flange 20, and the second outboard flange 22 all together as a monolith (reintroduced below) rather than injection molding (i) the first outboard flange 20, part of the outer cylinder portion 14, part of the inner cylinder portion 16, and part of the struts 18 as one piece and (ii) the second outboard flange 22, the other part of the cylinder portion, the other part of the inner cylinder portion 16, and the other part of the struts 18 as a second piece and then ultrasonically (or otherwise) welding the two pieces together. The latter welding would result in the thickness 32 of the outer cylinder portion 14 deviating where the weld was generated. In embodiments, the outer cylinder portion 14 is jointless and without a weld line between the first outboard flange 20 and the second outboard flange 22.

In addition to the outer cylinder portion 14, the axis of rotation 12 extends through the inner cylinder portion 16. The inner cylinder portion 16 includes an outer surface 36 and an inner surface 38. The outer surface 36 of the inner cylinder portion 16 faces the inner surface 26 of the outer cylinder portion 14. The inner surface 38 of the inner cylinder portion 16 faces the axis of rotation 12. The inner surface 38 of the inner cylinder portion 16 defines an inner channel 40 extending parallel to the axis of rotation 12. The inner cylinder portion 16 further extends axially (relative to the axis of rotation 12) parallel to the axis of rotation 12 from a first end 42 to a second end 44. The inner surface 38 can have a slight taper from the first end 42 and the second end 44 of the inner cylinder portion 16 toward an approximate axial midline 46 of the spool 10 between the first outboard flange 20 and the second outboard flange 22.

As mentioned, the spool 10 further includes the struts 18. The struts 18 are positioned radially about the axis of rotation 12. The struts 18 extend radially between the inner surface 26 of the outer cylinder portion 14 and the outer surface 36 of the inner cylinder portion 16, and are connected thereto. In addition, the struts 18 extend axially along the axis of rotation 12 between a first end 48 and a second end 50. The first end 48 of the struts 18 terminates near or radially flush with the first end 42 of the inner cylinder portion 16 and the first end 28 of the outer cylinder portion 14. The first end 28 of the outer cylinder portion 14 can extend axially beyond the first end 48 of the struts 18 (e.g., further away from the second end 50 of the struts 18 that the first end 48 of the struts 18). The second end 50 of the struts 18 terminate near but axially before the second end 44 of the inner cylinder portion 16 and the second end 30 of the outer cylinder portion 14. The outer cylinder portion 14, the inner cylinder portion 16, and the struts 18 define outer channels 52 disposed radially around the inner channel 40.

The first outboard flange 20 and the second outboard flange 22 each extend radially outward from the outer surface 24 of the outer cylinder portion 14. The first outboard flange 20 is disposed near or at the first end 28 of the outer cylinder portion 14. The second outboard flange 22 is disposed at or near (e.g., axially closer to the first outboard flange 20 than) the second end 30 of the outer cylinder portion 14. The first outboard flange 20, the second outboard flange 22, and the outer surface 24 of the outer cylinder portion 14 together define, at least in part, a primary barrel portion 54 of the spool 10. As further discussed below, the primary barrel portion 54 of the spool 10 receives most of a length of the optical fiber that the spool 10 in total receives.

In embodiments, the outer cylinder portion 14 further includes at least one projection 56. The at least one projection 56 projects out of the inner surface 26 of the outer cylinder portion 14 toward the axis of rotation 12. In addition, the at least one projection 56 extends axially parallel to the axis of rotation 12 between the first end 28 and the second end 30 of the of the outer cylinder portion 14. The at least one projection 56 can terminate axially before the second end 30 of the outer cylinder portion 14.

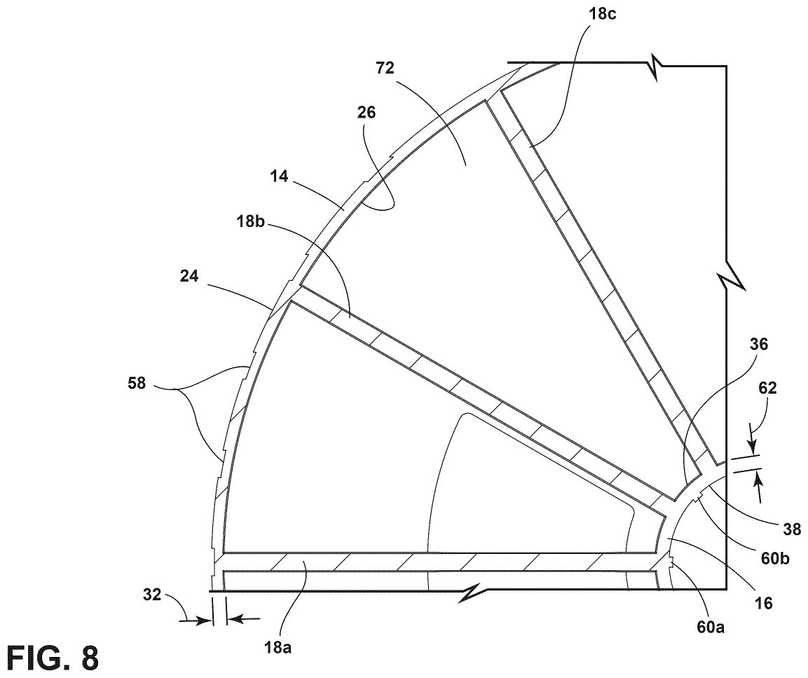

Referring additionally to FIG. 8, in embodiments, the outer cylinder portion 14 further includes indentations 58. The indentations 58 are into the outer surface 24 of the outer cylinder portion 14 toward the axis of rotation 12. Each of the indentations 58 extends axially parallel to the axis of rotation 12 between the first outboard flange 20 and the second outboard flange 22.

In embodiments, the inner cylinder portion 16 further includes projections 60. The projections 60 project out of the inner surface 26 and into the inner channel 40 toward the axis of rotation 12. Each of the projections 60 extends axially parallel to the axis of rotation 12 between the first end 42 and the second end 44 of the inner cylinder portion 16. Each of the projections 60 can terminate flush with the first end 42 and the second end 44 of the inner cylinder portion 16. Some of the projections 60 can be radially aligned with some of the struts 18 (e.g., the projection 60a is aligned with the strut 18a) while some of the projections 60 are not aligned with any of the struts 18 (e.g., the projection 60b is disposed radially between the strut 18b and the strut 18c).

In embodiments, the inner cylinder portion 16 further includes a thickness 62. The thickness 62 is between the outer surface 36 and the inner surface 38. The thickness 62 of the inner cylinder portion 16 is substantially constant, along the plane 34 extending through the thickness 62 and the axis of rotation 12, and between the first outboard flange 20 and the second outboard flange 22.

As for the struts 18, in embodiments, at least some of the struts 18 further include an aperture 64. The apertures 64 of the struts 18 are disposed near the second end 50 of the struts 18. As further discussed, the apertures 64 of the struts 18 can be utilized to provide a snap-fit opportunity for a lead meter endcap (reintroduced below) of the spool 10.

In embodiments, at least some of the struts 18 include an inner finger portion 66 and an outer finger portion 68. A gap 70 (radial) separates the inner finger portion 66 and the outer finger portion 68. The gap 70 is open at the second end 50 of the struts 18 and decreases toward the first end 48 of the struts 18.

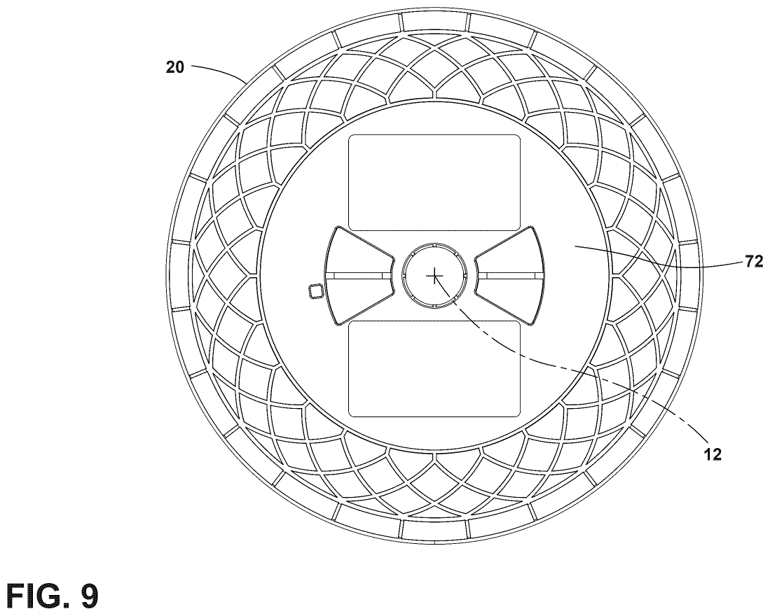

Referring additionally to FIG. 9, in embodiments, the spool 10 further includes a first radial wall 72. The first radial wall 72 is disposed between and joins with the outer cylinder portion 14 and the inner cylinder portion 16 near the first ends 28, 42 thereof. The first radial wall 72 at least partially closes the outer channels 52 but does not close the inner channel 40.

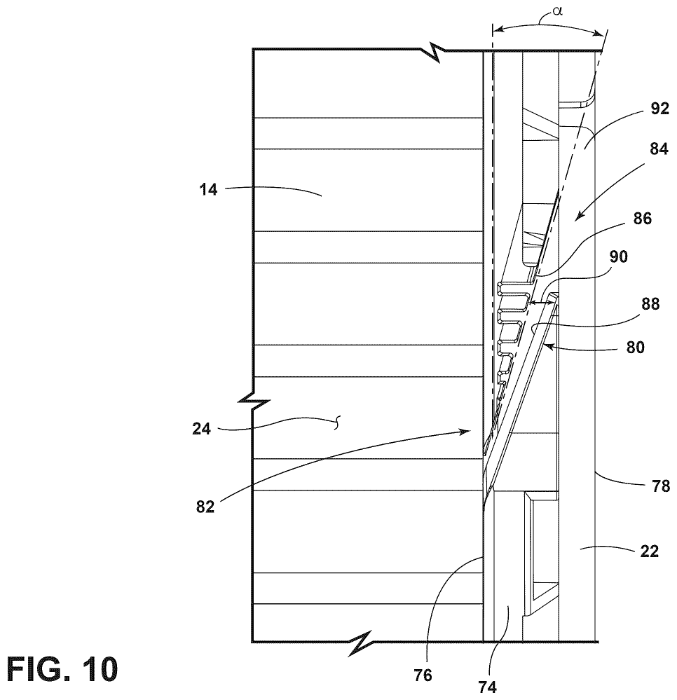

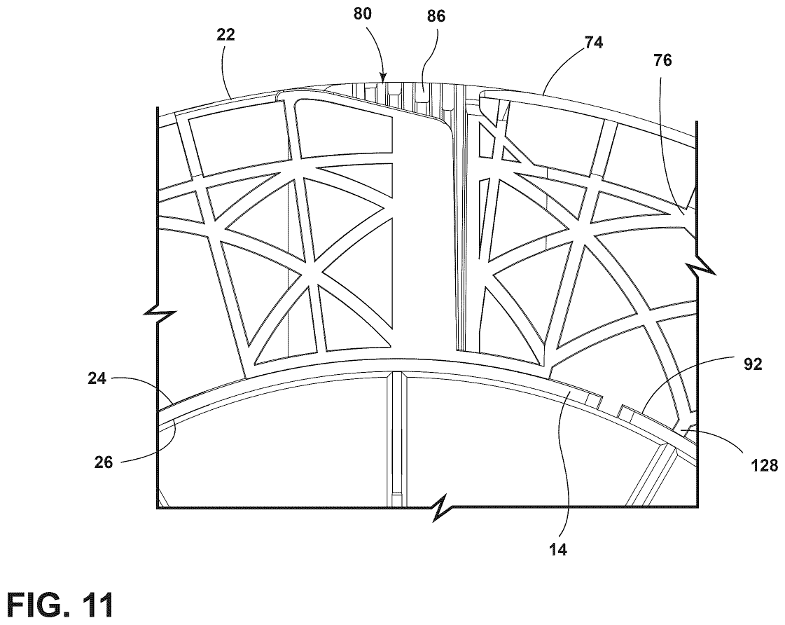

Referring additionally to FIGS. 10-11, in embodiments, the second outboard flange 22 includes an outer edge 74, an inner side 76, an outer side 78, and a slot 80. The outer edge 74 extends radially around the axis of rotation 12. The inner side 76 is generally orthogonal to the axis of rotation 12 between the outer surface 24 of the outer cylinder portion 14 to the outer edge 74. The inner side 76 faces the first outboard flange 20. The inner side 76 axially bounds the primary barrel portion 54 of the spool 10. The outer side 78 also extends between the outer surface 24 of the outer cylinder portion 14 to the outer edge 74 but faces away from the first outboard flange 20. The slot 80 is open at the outer edge 74, the inner side 76, and the outer side 78 of the second outboard flange 22. The slot 80 is disposed at an acute angle a relative to the inner side 76. The slot 80 extends radially inward from the outer edge 74 to the outer surface 24 of the outer cylinder portion 14. The optical fiber extends through the slot 80, as further discussed below.

The slot 80 includes an inboard side 82 and an outboard side 84. The inboard side 82 is disposed at the inner side 76 of the second outboard flange 22. The outboard side 84 is disposed at the outer side 78 of the second outboard flange 22. The second outboard flange 22 further includes a lead-in surface 86 and working surface 88. The lead-in surface 86 and the working surface 88 oppose each other and define at least in part the slot 80. The lead-in surface 86 can be serrated, as illustrated. The lead-in surface 86 can taper to the outer edge 74 of the second outboard flange 22. A slot gap 90 separates the lead-in surface 86 and the working surface 88. The slot gap 90 increases from the inboard side 82 toward the outboard side 84. A radial distance from the axis of rotation 12 of the working surface 88 decreases from the inboard side 82 of the slot 80 to the outboard side 84 of the slot 80.

In embodiments, the second outboard flange 22 is inset axially toward the first outboard flange 20 from the second end 30 of the outer cylinder portion 14. A portion 92 of the outer surface 24 of the outer cylinder portion 14 is thus exposed axially outward of the second outboard flange 22.

In embodiments, the outer cylinder portion 14, the inner cylinder portion 16, the struts 18, the first outboard flange 20, and the second outboard flange 22 are all integrally formed from a plastic composition in common as an injection molded monolith 94. Stated another way, the injection molded monolith 94, which includes the outer cylinder portion 14, the inner cylinder portion 16, the struts 18, the first outboard flange 20, and the second outboard flange 22, is injection molded as one piece. Molding these components of the spool 10 as a single piece—the injection molded monolith 94—permits the thickness 32 of the outer cylinder portion 14 to be substantially constant axially from the first outboard flange 20 to the second outboard flange 22. Structural integrity is gained, and loss of strength arising from weld lines and other joints from fusing multiple pieces of the spool 10 (e.g., a first piece with the first outboard flange 20 and part of the outer cylinder portion 14 and a second piece with the second outboard flange 22 and the other part of the outer cylinder portion 14) is avoided. In addition, the plastic composition can be 100 percent recycled plastic material and need not include virgin plastic material. Structural strength specifications are met by forming the injection molded monolith 94 with 100 percent recycled plastic material.

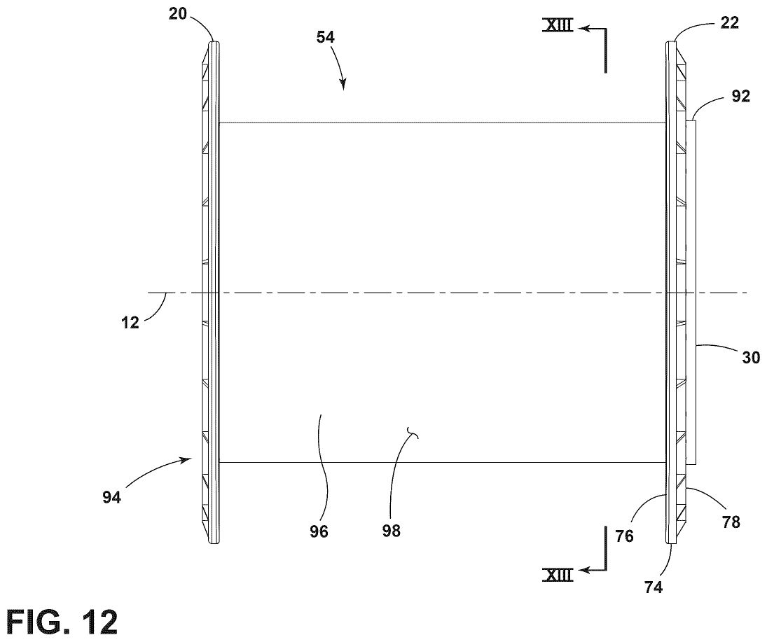

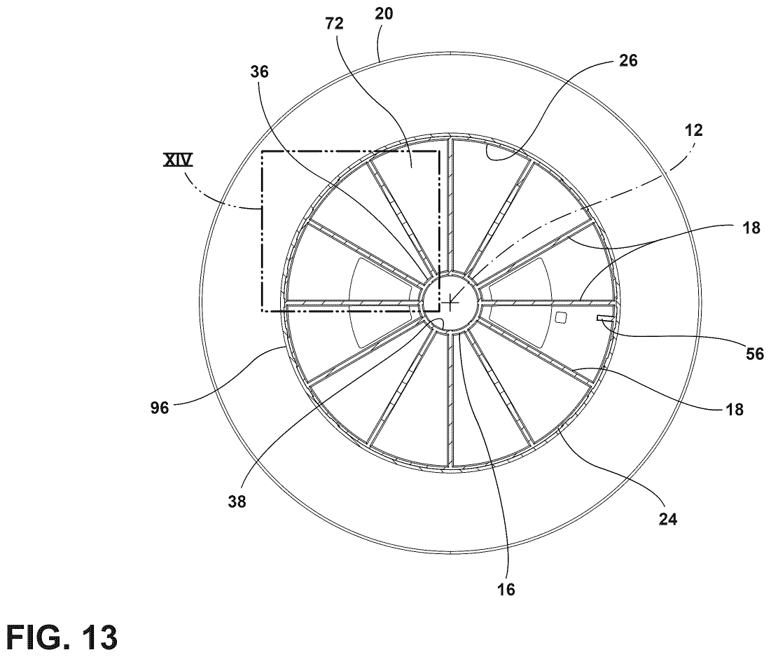

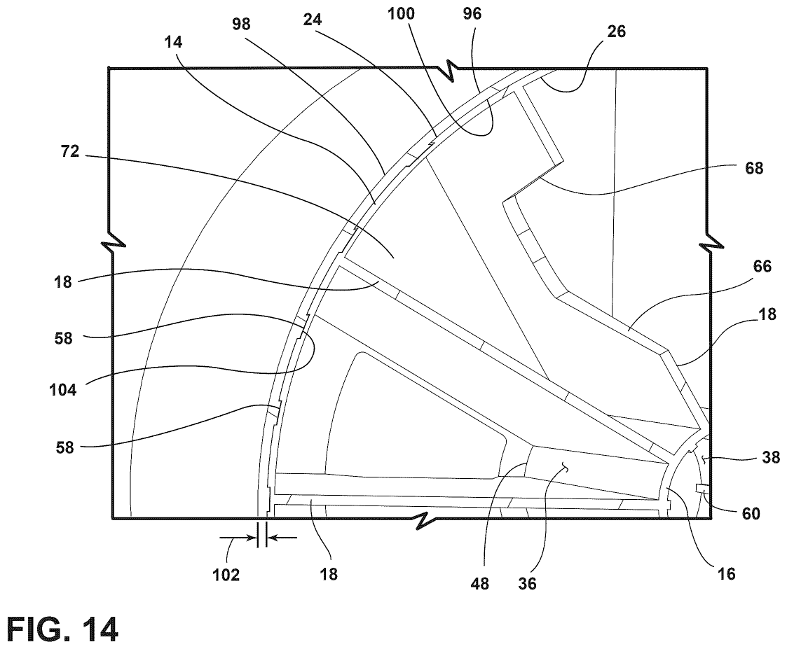

Referring additionally to FIGS. 12-14, in embodiments, the spool 10 further includes a polymeric cushioning material 96. The polymeric cushioning material 96 is disposed on the outer surface 24 of the outer cylinder portion 14 and extends axially between the first outboard flange 20 and the second outboard flange 22. In such embodiments, the primary barrel portion 54 further includes the polymeric cushioning material 96. The polymeric cushioning material 96 can abut the first outboard flange 20 and the second outboard flange 22. The polymeric cushioning material 96 includes an outer surface 98, an inner surface 100, and a thickness 102. The outer surface 98 of the polymeric cushioning material 96 faces away from the axis of rotation 12. The inner surface 100 of the polymeric cushioning material 96 contacts the outer surface 24 of the outer cylinder portion 14. The thickness 102 is the radial distance between the outer surface 98 and the inner surface 100.

In embodiments, the polymeric cushioning material 96 includes projections 104. The projections 104 project out of the inner surface 100 of the polymeric cushioning material 96 toward the axis of rotation 12. The projections 104 reside (e.g., are disposed within) the indentations 58 of the outer cylinder portion 14. The mating of the projections 104 of the polymeric cushioning material 96 and the indentations 58 of the outer cylinder portion 14 help resist rotational movement of the polymeric cushioning material 96 over the outer surface 24 of the outer cylinder portion 14.

In embodiments, the polymeric cushioning material 96 is seamless and jointless. For example, the polymeric cushioning material 96 lacks edges circumferentially around the outer cylinder portion 14. The polymeric cushioning material 96 in such embodiments is not a rectangular piece that is then wrapped around and adhered to the outer cylinder portion 14.

In embodiments, the polymeric cushioning material 96 is a plastic composition over-molded over the outer cylinder portion 14 of the injection molded monolith 94 of the spool 10 between the first outboard flange 20 and the second outboard flange 22. The over-molding permits the projections 104 of the polymeric cushioning material 96 within the indentations 58 of the outer cylinder portion 14.

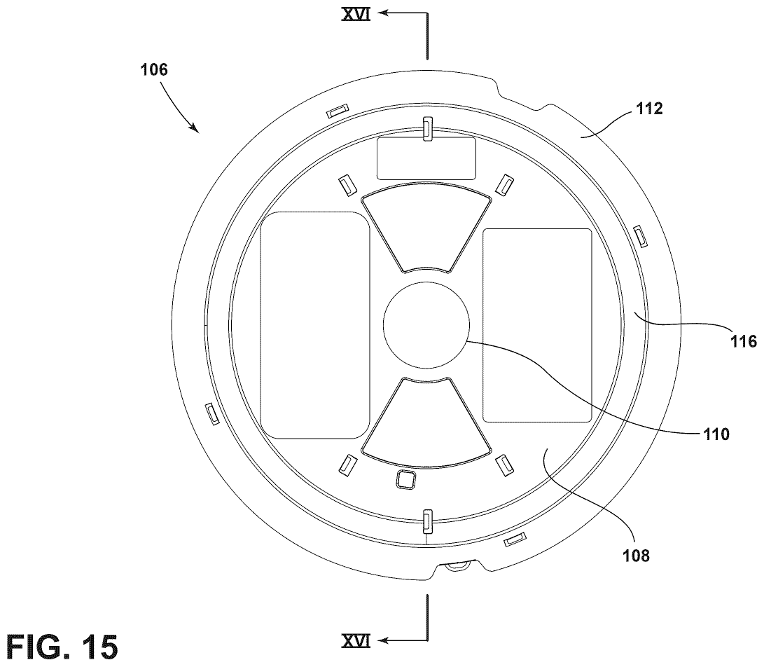

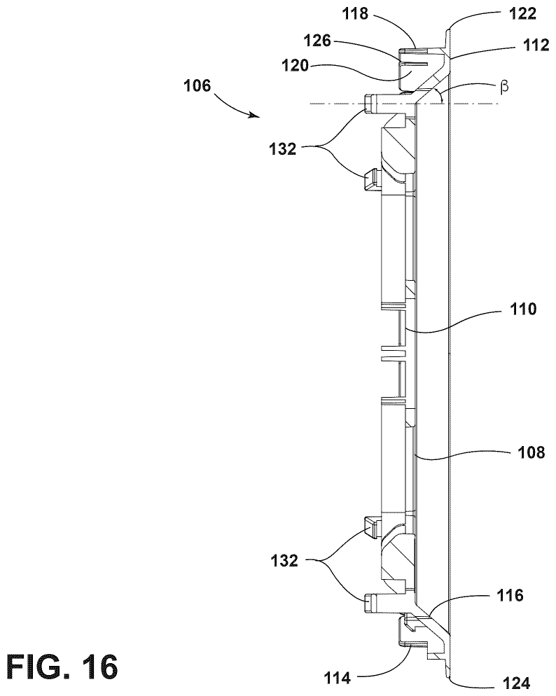

Referring additionally to FIGS. 15-16, in embodiments, the spool 10 further includes a lead meter endcap 106. The lead meter endcap 106 includes an inner wall 108, an aperture 110 through the inner wall 108, an outer wall 112, and a cylindrical wall 114. The inner wall 108 is disposed radially around the axis of rotation 12 and extends orthogonal to the axis of rotation 12. The inner wall 108 of the lead meter endcap 106 at least partially covers the outer channels 52 at the second end 50 of the struts 18. The aperture 110 of the lead meter endcap 106 is through the inner wall 108 and is centrally disposed around the axis of rotation 12. The aperture 110 provides access into the inner channel 40 that the inner cylinder portion 16 defines.

The outer wall 112 of the lead meter endcap 106 is disposed radially around the inner wall 108 and the axis of rotation 12. The outer wall 112 extends orthogonally to the axis of rotation 12. The outer wall 112 is generally parallel to the inner wall 108 of the lead meter endcap 106 but disposed axially outboard of (e.g., further away from the first outboard flange 20 than) the inner wall 108 of the lead meter endcap 106. The lead meter endcap 106 can include a transition wall 116 to transition between the inner wall 108 and the outer wall 112 of the lead meter endcap 106. The transition wall 116 extends radially around the axis of rotation 12 but additionally extends axially at an acute angle β relative to the axis of rotation 12 from the inner wall 108 away from the first outboard flange 20.

The cylindrical wall 114 of the lead meter endcap 106 is disposed radially around the axis of rotation 12 and extends axially inward from the outer wall 112 toward the second outboard flange 22. The cylindrical wall 114 includes an outer surface 118 facing away from the axis of rotation 12 and an inner surface 120 facing the axis of rotation 12. The inner surface 120 is disposed closer to the axis of rotation 12 than the outer surface 118. The outer wall 112 can include an outer portion 122 that extends outward of the outer surface 118 of the cylindrical wall 114. The outer portion 122 can provide a radial edge 124 of the lead meter endcap 106. The cylindrical wall 114 can include slots 126 to receive segments 128 of the second outboard flange 22 at the outer side 78 thereof.

The outer side 78 of the second outboard flange 22, the outer surface 118 of the cylindrical wall 114 of the lead meter endcap 106, and the outer portion 122 of the outer wall 112 of the lead meter endcap 106 together define a lead meter barrel 130. As further explained, in use of the spool 10, the lead meter barrel 130 receives the beginning length of the optical fiber while the primary barrel portion 54 of the spool 10 receives the remainder of the optical fiber.

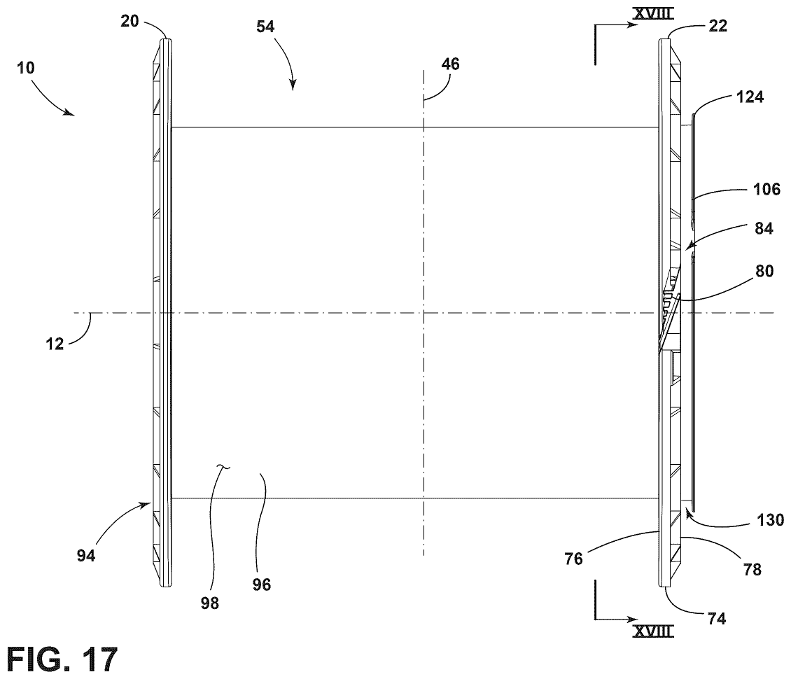

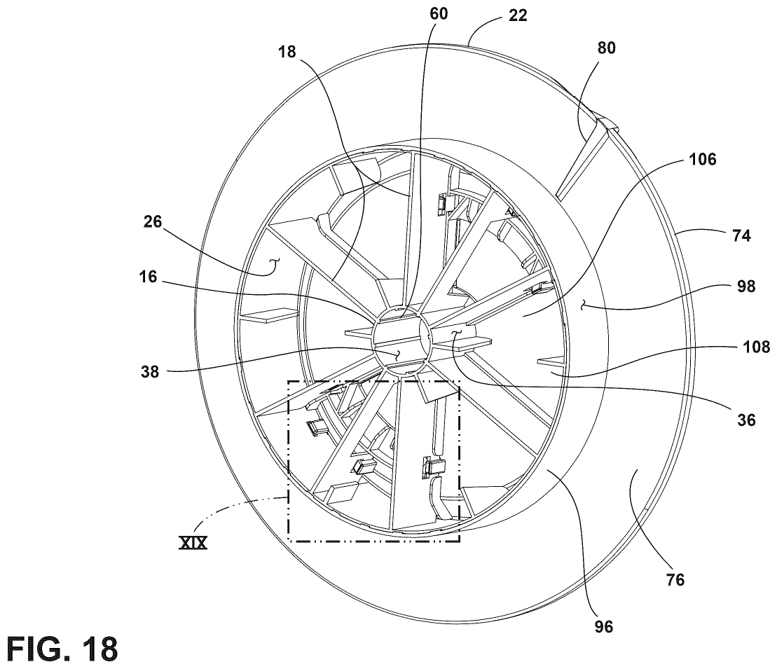

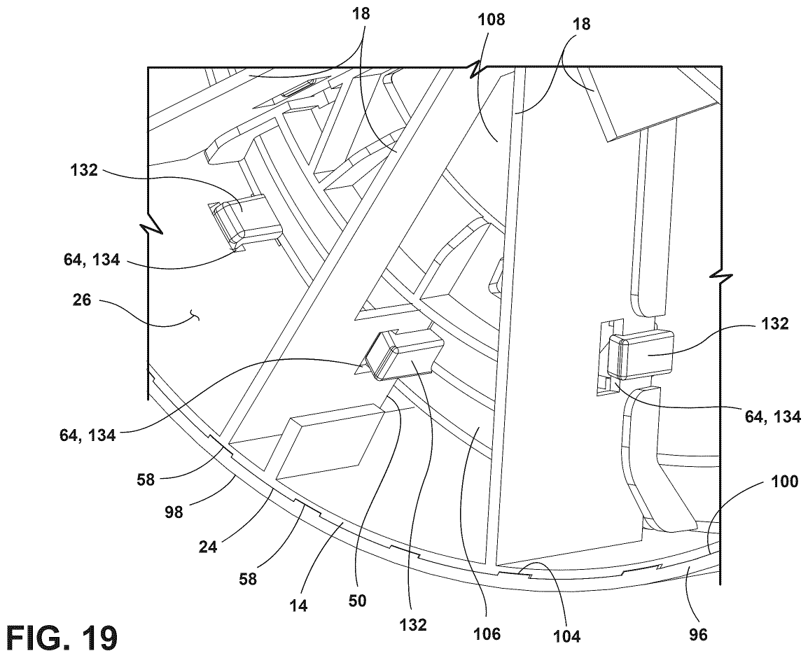

Referring additionally to FIGS. 17-19, in embodiments, the lead meter endcap 106 is snap-fit attached to the outer cylinder portion 14 and the struts 18 axially outboard of the second outboard flange 22. For example, the lead meter endcap 106 can further include snap-fit cantilevers 132, such as extending inboard from the inner wall 108 and the transition wall 116 toward the second outboard flange 22. Some of the snap-fit cantilevers 132 can oppose the cylindrical wall 114. In turn, the outer cylinder portion 14 and the struts 18 both can include snap-fit apertures 134 that cooperate with the snap-fit cantilevers 132 of the lead meter endcap 106 to attach the lead meter endcap 106 to the outer cylinder portion 14 and the struts 18.

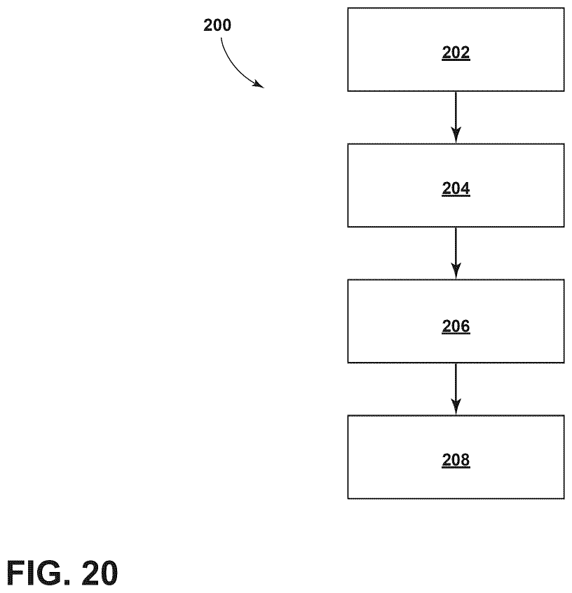

Referring now to FIG. 20, a method 200 of manufacturing the spool 10 is herein described. The method 200 includes a monolith injection molding step 202 and an over-molding step 204. The monolith injection molding step 202 includes injection molding, from a plastic composition, the injection molded monolith 94. Any injection molding process known in the art can be utilized. In embodiments, the plastic composition of the monolith injection molding step 202 comprises, consists essentially of, or consists of acrylonitrile butadiene styrene. In embodiments, the plastic composition of the monolith injection molding step 202 comprises, consists essentially of, or consists of recycled plastic (e.g., recycled acrylonitrile butadiene styrene). The injection molded monolith 94 is formed without a plastic welding step.

The over-molding step 204 includes over-molding, from a plastic composition, the polymeric cushioning material 96 over the outer cylinder portion 14 of the injection molded monolith 94 between the first outboard flange 20 and the second outboard flange 22. Again, any over-molding process known in the art can be utilized. In embodiments, the plastic composition of the over-molding step 204 is a cushioning material. In embodiments, the plastic composition of the over-molding step 204 is a foam but need not be. In embodiments, the plastic composition of the over-molding step 204 is miscible with the plastic composition of the monolith injection molding step 202. The miscibility permits the plastic polymeric cushioning material 96 of the spool 10 to be separated from the injection molded monolith 94 and the lead meter endcap 106, during recycling of the spool 10 after use thereof.

In embodiments, the method 200 further includes an endcap injection molding step 206. The endcap injection molding step 206 includes injection molding, from a plastic composition, the lead meter endcap 106. The plastic compositions injection molded during the monolith injection molding step 202 and the endcap injection molding step 206 can be the same (e.g., recycled acrylonitrile butadiene styrene).

In embodiments, the method 200 further includes an endcap attaching step 208. The endcap attaching step 208 includes attaching the lead meter endcap 106, in a snap-fit fashion, to the injection molded monolith 94. For example, the lead meter endcap 106 is positioned so that the snap-fit cantilevers 132 of the lead meter endcap 106 enter and then snap over the snap-fit apertures 134 of the injection molded monolith 94 at the outer cylinder portion 14 and the struts 18.

The spool 10 and the method 200 of the present disclosure address the problems set forth in the Background, in a variety of ways. The method 200 forms the lead meter barrel 130 of the spool 10 with the injection molded monolith 94 and the polymeric cushioning material 96 in sequential molding steps 202, 204. The injection molded monolith 94 is one piece. There is no welding of two separate plastic pieces. Thus, the time and expense of the welding are avoided. Further, the possibility of the welded pieces being out of specification is avoided. Still further, because the injection molded monolith 94 is a single piece, structural weakness because of a weld line is avoided. Thus, the plastic composition forming injection molded monolith 94 can be entirely recycled material. A need to include a large amount of virgin plastic material is avoided. Still further, because the polymeric cushioning material 96 is over-molded over the outer cylinder portion 14, the polymeric cushioning material 96 is less likely to lift off the injection molded monolith 94 during winding of the optical fiber on the spool 10.

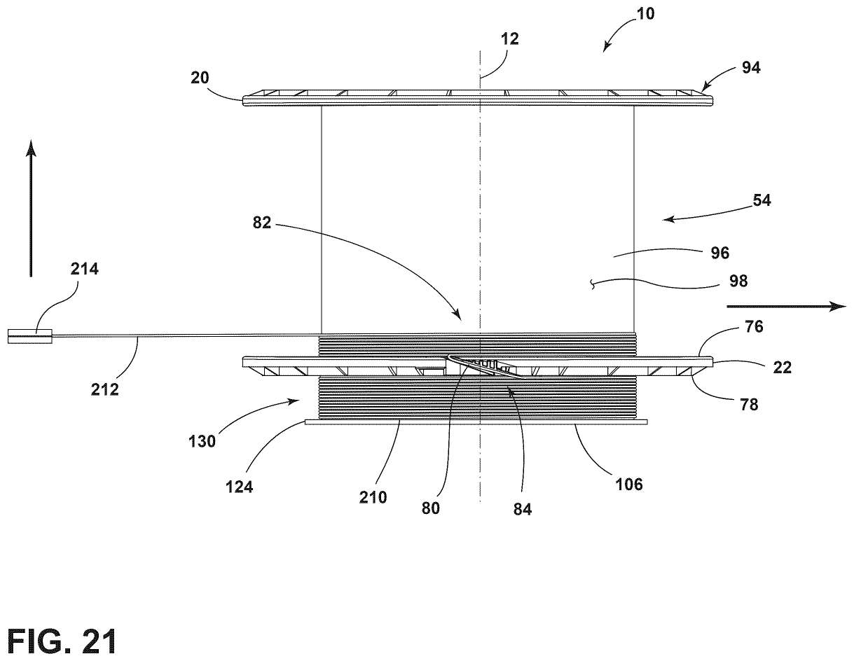

Referring now to FIG. 21, in use, the spool 10 is mounted onto a rotatable spindle assembly. The end 210 of an optical fiber 212 is affixed to the lead meter barrel 130, proximate to the outer portion 122 of the outer wall 112 of the lead meter endcap 106. The spool 10 is then rotated, and the optical fiber 212 begins to wind onto the lead meter barrel 130.

The optical fiber 212 is fed to the spool 10 by means of a flying head 214. As the optical fiber 212 winds onto the lead meter barrel 130, the flying head 214 moves toward the first outboard flange 20 at a rate that has been calculated with respect to the diameter of the spool 10, the width of the optical fiber 212, and the speed at which the spool 10 is rotated, such that the combined rotation of the spool 10 and motion of the flying head 214 cause the optical fiber 212 to be wound onto the lead meter barrel 130 and the primary barrel portion 54 in an even spiral, in which each row of the spiral immediately abuts the previous row. The distance between consecutive rows in the spiral is known as the winding “pitch,” which can be adjusted by changing the speed at which the flying head 214 moves upward or downward (or back and forth, depending upon the orientation of winding) relative to the rotating spool 10. During this portion of the winding process, the angle of the optical fiber 212 relative to the flying head 214 remains substantially flat, approximating 180 degrees, as the velocity of the flying head 214 is approximately equal to the fiber transverse velocity, i.e., the speed at which the spiral of the optical fiber 212 progresses up the length of the lead meter barrel 130.

The optical fiber 212 continues to be wound onto the lead meter barrel 130 until the flying head 214 has advanced to the point at which the optical fiber 212 makes contact with the second outboard flange 22. At this point, the lead meter barrel 130 has been fully wound with the optical fiber 212.

The flying head 214 continues to move upward, but the optical fiber 212 transverse velocity stagnates as the spiral progression of the optical fiber 212 wound onto the lead meter barrel 130 is temporarily blocked by the second outboard flange 22. Thus, the flying head 214 has continued to advance, but, because of the presence of the second outboard flange 22, the optical fiber 212 being wound onto the lead meter barrel 130 now lags behind the flying head 214.

As the flying head 214 traverses beyond the outer side 78 of the second outboard flange 22, the optical fiber 212 is urged against the lead-in surface 86 of the slot 80. The working surface 88 of the slot 80 opposite the lead-in surface 86 is configured such that the optical fiber 212 is accelerated through the slot 80 to the inner side 76 of the second outboard flange 22 with an acceptably low level of impact to optical fiber 212 tension and coating.

The optical fiber 212 has been accelerated through the slot 80 and onto the primary barrel portion 54. Because of the acceleration to the optical fiber 212 imparted by the slot 80, which functions essentially as a cam, the optical fiber 212 being wound onto the spool 10 now leads the flying head 214, which has continued to move upward at a constant rate of speed. Because the flying head 214 now lags behind the optical fiber 212 being wound onto the primary barrel portion 54, the optical fiber 212 now begins to build up at the slot 80 outlet side of the second outboard flange 22.

The buildup of the optical fiber 212 continues until the flying head 214 “catches up” with the optical fiber 212. At this point, a normal wrap process commences, in which the flying head 214 moves back and forth between the first outboard flange 20 and second outboard flange 22. Because of the angle and geometry of the slot 80, the optical fiber 212 cannot be drawn back into the slot 80 once the normal wrap has begun.

While exemplary embodiments and examples have been set forth for the purpose of illustration, the foregoing description is not intended in any way to limit the scope of disclosure and appended claims. Accordingly, variations and modifications may be made to the above-described embodiments and examples without departing substantially from the spirit and various principles of the disclosure. All such modifications and variations are intended to be included herein within the scope of this disclosure and protected by the following claims.

What is claimed is:

1. A spool for receiving an optical fiber comprising:
an outer cylinder portion through which an axis of rotation of the spool extends, the outer cylinder portion comprising (i) an outer surface facing away from the axis of rotation, (ii) an inner surface facing the axis of rotation, the outer cylinder portion extending parallel to the axis of rotation from a first end to a second end, and (iii) a thickness between the outer surface and the inner surface;
an inner cylinder portion through which the axis of rotation of the spool extends, the inner cylinder portion comprising (i) an outer surface facing the inner surface of the outer cylinder portion, (ii) an inner surface facing the axis of rotation and defining an inner channel, the inner cylinder portion extending parallel to the axis of rotation from a first end and a second end;
struts extending between the inner surface of the outer cylinder portion and the outer surface of the inner cylinder portion, the struts extending axially along the axis of rotation between (i) a first end terminating near the first end of the inner cylinder portion and the first end of the outer cylinder portion and (ii) a second end terminating near the second end of the inner cylinder portion and the second end of the outer cylinder portion, and the struts positioned radially about the axis of rotation, wherein the outer cylinder portion, the inner cylinder portion and the struts define outer channels; and
a first outboard flange and a second outboard flange each extending radially outward from the outer surface of the outer cylinder portion proximate the first end and the second end respectively of the outer cylinder portion, the first outboard flange, the second outboard flange, and the outer surface of the outer cylinder portion defining a primary barrel portion of the spool;
wherein, the thickness of the outer cylinder portion is substantially constant, along a plane extending through the thickness and the axis of rotation and between the first outboard flange and the second outboard flange.

2. The spool of claim 1, wherein
the outer cylinder portion is jointless and without a weld line between the first outboard flange and the second outboard flange.

3. The spool of claim 1, wherein
the outer cylinder portion further comprises at least one projection that projects out of the inner surface of the outer cylinder portion toward the axis of rotation, the at least one projection extending axially parallel to the axis of rotation between the first end and the second end of the outer cylinder portion.

4. The spool of claim 1, wherein
the outer cylinder portion further comprises indentions into the outer surface toward the axis of rotation, each of the indentions extending axially parallel to the axis of rotation between the first outboard flange and the second outboard flange.

5. The spool of claim 1, wherein
the inner cylinder portion further comprises projections that project out of the inner surface and into the inner channel toward the axis of rotation, each of the projections extending axially parallel to the axis of rotation between the first end and the second end of the inner cylinder portion.

6. The spool of claim 1, wherein
the inner cylinder portion further comprises a thickness between the outer surface and the inner surface, and
the thickness of the inner cylinder portion is substantially constant, along a plane extending through the thickness and the axis of rotation and between the first outboard flange and the second outboard flange.

7. The spool of claim 1, wherein
at least some of the struts further comprise an aperture disposed near the second end of the struts.

8. The spool of claim 1, wherein
at least some of the struts comprise an inner finger portion and an outer finger portion separated from the inner finger portion by a gap open at the second end of the struts, the gap decreasing toward the first end of the struts.

9. The spool of claim 1 further comprising
a first radial wall disposed between the outer cylinder portion and the inner cylinder portion near the first ends thereof and at least partially closing the outer channels but not closing the inner channel.

10. The spool of claim 1, wherein
the second outboard flange comprises (i) an outer edge that extends radially around the axis of rotation, (ii) an inner side orthogonal to the axis of rotation and that faces the first outboard flange, (iii) an outer side that faces away from the first outboard flange, and (iv) a slot open at the outer edge, the inner side, and the outer side of the second outboard flange, the slot disposed at an acute angle relative to the inner side and extending to the outer surface of the outer cylindrical portion.

11. The spool of claim 1, wherein
second outboard flange is inset axially toward the first outboard flange from the second end of the outer cylinder portion, and
a portion of the outer surface of the outer cylinder portion is exposed axially outward of the second outboard flange.

12. The spool of claim 1, wherein
the outer cylinder portion, the inner cylinder portion, the struts, the first outboard flange, and the second outboard flange are all integrally formed from a plastic composition in common as an injection molded monolith.

13. The spool of claim 1 further comprising:
a polymeric cushioning material disposed on the outer surface of the outer cylinder portion between the first outboard flange and the second outboard flange.

14. The spool of claim 13, wherein
the polymeric cushioning material comprises (i) an outer surface facing away from the axis of rotation, (ii) an inner surface contacting the outer surface of the outer cylinder portion, and (iii) a thickness between the outer surface and the inner surface.
wherein
the outer cylinder portion further comprises indentions into the outer surface toward the axis of rotation, each of the indentions extending axially parallel to the axis of rotation between the first outboard flange and the second outboard flange, and
the polymeric cushioning material further comprises projections out of the inner surface of the polymeric cushioning material toward the axis of rotation, the projections residing within the indentions of the outer cylinder portion.

15. The spool of claim 13, wherein
the polymeric cushioning material is seamless and jointless.

16. The spool of claim 13, wherein
the outer cylinder portion, the inner cylinder portion, the struts, the first outboard flange, and the second outboard flange are all integrally formed from a plastic composition in common as an injection molded monolith, and
the polymeric cushioning material is over-molded over the outer cylinder portion of the injection molded monolith of the spool between the first outboard flange and the second outboard flange.

17. The spool of claim 1 further comprising:
a lead meter endcap at least partially covering the outer channels at the second end of the struts, the lead meter endcap comprising: (i) an inner wall disposed radially around the axis of rotation and extending orthogonal to the axis of rotation, (ii) an aperture through the inner wall, the aperture providing access into the inner channel that the inner cylinder portion defines, (iii) an outer wall disposed radially around the inner wall and the axis of rotation and extending orthogonal to the axis of rotation, and (iv) a cylindrical wall disposed radially around the axis of rotation and extending axially inward from the outer wall toward the second outboard flange, the cylindrical wall comprising an outer surface and an inner surface disposed closer to the axis of rotation than the outer surface, and the outer wall includes an outer portion that extends radially outward of the outer surface of the cylindrical wall.

18. A method of manufacturing a spool for optical fiber comprising:
a monolith injection molding step comprising injecting molding, from a plastic composition, an injection molded monolith comprising a first outboard flange, a second outboard flange, and a cylindrical portion therebetween; and
an over-molding step comprising over-molding, from a plastic composition, a polymeric cushioning material over the cylindrical portion of the injection molded monolith between the first outboard flange and the second outboard flange, wherein the first outboard flange, the second outboard flange, and the polymeric cushioning material define a primary barrel of the spool.

19. The method of claim 18, wherein
injection molded monolith is formed without a plastic welding step.

20. The method of claim 17, wherein
the plastic composition of the over-molding step is miscible with the plastic composition of the monolith injection molding step.
